(19) United States
(12) Patent Application Publication
(10) Pub. No.: US 2024/0375861 A1
(43) Pub. Date: Nov. 14, 2024

(54) LIFTING DEVICE

(71) Applicant: Perkins Manufacturing Co., Bolingbrook, IL (US)

(72) Inventor: James Rimsa, Shorewood, IL (US)

(21) Appl. No.: 18/315,675

(22) Filed: May 11, 2023

(51) Int. Cl. B65F 3/04; B65F 3/20

(52) U.S. Cl. CPC B65F 3/041; B65F 3/201; B65F 2003/0246

(57) ABSTRACT

A lifting device for use in lifting and dumping a refuse container, the lifting device comprising: a base connected to a frame that supports the lifting device, a body movably connected to the base and configured to engage the refuse container, an electrically powered linear actuator connected to the base and to the body, wherein the lifting device is configured to move the body from a lower position to a pick-up position to engage the refuse container when the refuse container is on a ground surface and to further move to an upper position to dump contents from the refuse container, and to move the body to the pick-up position to return the refuse container to the ground surface.

### BACKGROUND

### Field of the Disclosure

The present disclosure relates to lifting devices. More particularly, the present disclosure relates to improved lifting devices and methods, including electrically powered lifting devices for use in lifting and dumping refuse containers.

### Description of Related Art

Various lifting devices have been utilized for lifting refuse containers to dump such containers, typically into a refuse vehicle, such as may be commonly referred to as a garbage truck. Such lifting devices alleviated the need for a refuse vehicle operator to rely on the operator's strength to manually move, lift and dump bags or refuse containers into a hopper, such as may define a cavity in a refuse vehicle. Many lifting devices have been developed, which utilize hydraulic power provided by systems on a refuse vehicle. Such hydraulic lifting devices may permit more hands-free time for an operator to conveniently move a refuse receptacle, typically in the form of a plastic container, to a location near the lifting device. The operator then would operate a lever to cause the lifting device to engage, lift and dump the refuse container into the vehicle cavity while the operator moves the lever between operational positions. Upon further movement of the lever, the lifting device would return the container to the ground surface.

### SUMMARY

The disclosure pertains to improved lifting devices that are electrically powered. The lifting devices are configured to be connected to a frame, such as a stationary stand along a conveyor, a freestanding hopper or a hopper integrated into or carried by a refuse vehicle. If a refuse vehicle is fossil fueled and has hydraulic systems, the electrically powered lifting device will forego requiring some of the hydraulic systems to be dedicated to operating a hydraulically powered lifting device. The electrically powered lifting device also may be installed on a refuse vehicle that is partially or entirely electrically powered. The lifting device utilizes a DC electrical power source, whether provided via a dedicated battery, a vehicle battery or other electrical power generating system. This also makes the lifting device ideally suited for use on a stationary stand or freestanding hopper, either of which may include an electrical power source.

The lifting devices may be used to lift and dump refuse containers, whether onto a conveyor or into a refuse collection cavity, such as a cavity of a freestanding hopper or a hopper integrated into or carried by a vehicle. The vehicle or freestanding hopper may be electrically powered. They may or may not otherwise provide hydraulic systems, such as would be needed to operate a hydraulically powered lifting device. Indeed, this may contribute to the elimination of the need for hydraulic systems on refuse vehicles and/or permitting entirely electrically powered stationary stands, freestanding hoppers or refuse vehicles having refuse collection hoppers.

The lifting devices are constructed and configured to permit connection to a frame, such as may be provided by a stationary stand, or a hopper that may be freestanding or integrated into or carried by a refuse vehicle. The lifting devices may be connected in a location to achieve a lower position when not in use. This may be particularly advantageous when the lifting device is connected to a hopper on a refuse vehicle. Having the lifting device in the lower position helps to provide unobstructed access to the vehicle for dumping other larger refuse containers or manually throwing smaller items into the collection cavity of the hopper. The lower position also may help to avoid contact with the ground during driving of the vehicle.

A principal feature of the present disclosure is the provision of an improved lifting device for lifting and dumping a refuse container into a cavity of a hopper, wherein the lifting device is not hydraulically powered. As disclosed herein, the lifting device of the present application is electrically powered and utilizes a linear actuator, which should permit a relatively reliable and compact configuration. The lifting devices have at least a lower position, an intermediate pick-up position and an upper position for dumping a refuse container.

The present disclosure provides several aspects of the subject matter which may be embodied separately or together in the devices and systems described and claimed herein. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a lifting device is provided for use in lifting and dumping a refuse container, the lifting device comprising: a base connected to a frame that supports the lifting device, a body movably connected to the base and configured to engage the refuse container, an electrically powered linear actuator connected to the base and to the body, wherein the lifting device is configured to move the body from a lower position to a pick-up position to engage the refuse container when the refuse container is on a ground surface and to further move to an upper position to dump contents from the refuse container, and to move the body to the pick-up position to return the refuse container to the ground surface.

### BRIEF DESCRIPTION OF DRAWINGS

In describing the preferred example embodiments, reference is made to the accompanying drawing figures wherein like parts have like reference numerals, and wherein:

FIG. 1 is a fragmentary perspective view illustrating two similar example lifting devices connected to frame, in the form of a hopper, with a first lifting device on the left in a lower position and a second lifting device on the right holding a refuse container in an upper position, and the hopper being integrated into the rear of a refuse vehicle;

FIG. 2 is a front left perspective view of the example lifting device of FIG. 1, in a pick-up position for engaging a refuse container on a ground surface;

FIG. 3 is a front left perspective view of the example lifting device of FIGS. 1-2, in the upper position used to dump contents from a refuse container;

FIGS. 4A-4C are diagrammatic left side views showing the range of motion of the example lifting device of FIGS. 1-3, including the lower, pick-up and upper positions, respectively;

FIG. 5 is a perspective view of an electrically powered linear actuator utilized in the example lifting device of FIGS. 1-3;

FIG. 6 is a perspective view of a common refuse container that may be lifted and dumped by the example lifting device, such as is shown in FIG. 1;

FIG. 7 is a perspective view of an exemplary operator interface for operating the example lifting device of FIGS. 1-3;

FIG. 8 is a diagrammatic view of an example controller enclosure for use in operating the example lifting device of FIGS. 1-3; and

FIG. 9 is a diagrammatic perspective view of an example position sensor that indicates the position of the example lifting device to the controller.

It should be understood that the drawings are not necessarily to scale, with some views enlarged for enhanced viewing. While some details of the example lifting devices, including details of fastening means and other plan and section views of the particular components may not be shown, such details are considered to be within the comprehension of those skilled in the art in light of the present disclosure. It also should be understood that the present disclosure and claims are not limited to the preferred embodiments illustrated.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

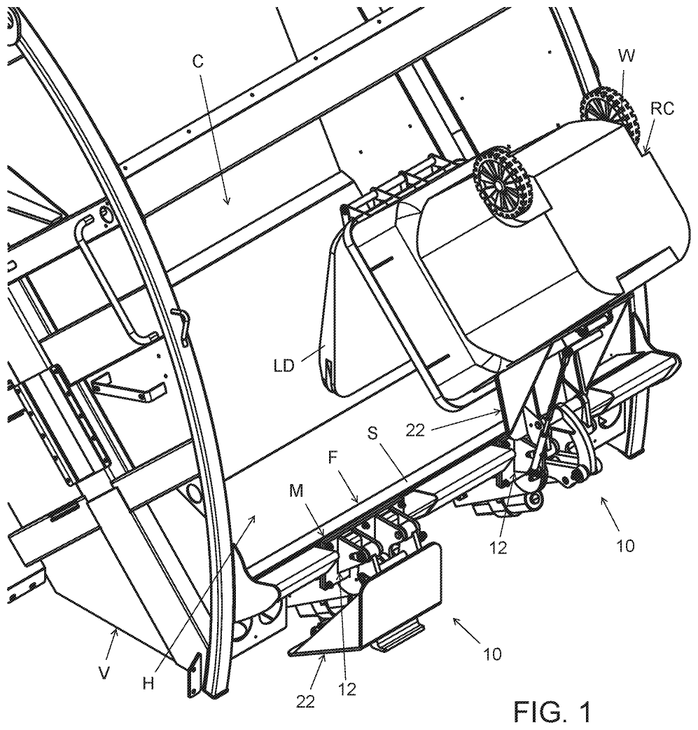

Referring generally to FIGS. 1-9, it will be appreciated that lifting devices of the present disclosure may be embodied in numerous configurations and for connection to various structures that may be referred to as having a frame. For example, the frame may further comprise a stationary stand, or a hopper that may be freestanding or integrated into or carried by a refuse vehicle. The teachings within this disclosure pertain to electrically powered lifting devices connected to such a frame and being used to lift and dump the contents of refuse containers, such as on to a conveyor or into the cavity of a hopper.

For instance, FIG. 1 illustrates an example embodiment of a lifting device 10 for use in lifting and dumping a refuse container. In this example, the lifting device 10 is connected to a frame F, which further embodies hopper H. In this example, the hopper H is incorporated into a refuse vehicle V to provide a collection cavity C. The example frame F includes a rear sill S of the hopper H, at the rear of the refuse vehicle V, which may be otherwise referred to as a garbage truck.

FIG. 1 illustrates two identical lifting devices 10, which are shown connected on left and right sides of the frame F, by being mounted to the rear sill S of the hopper H. It will be appreciated that a single lifting device 10 or a plurality of lifting devices 10 may be mounted in left, right and/or centered positions on the frame F. The lifting devices may be of identical structure, or different structures to facilitate lifting and dumping refuse containers having different configurations.

In FIG. 1, the frame F further comprises the hopper H of the vehicle V, and the hopper H has a collection cavity C. The collection cavity C is defined by walls of the hopper H, such as at least a bottom wall and side walls which together form the hopper H. The example hopper H extends forward from the rear sill S of the hopper H. The collection cavity C defined by the hopper H receives and retains refuse collected by dumping of refuse containers, and potentially by other means of collection.

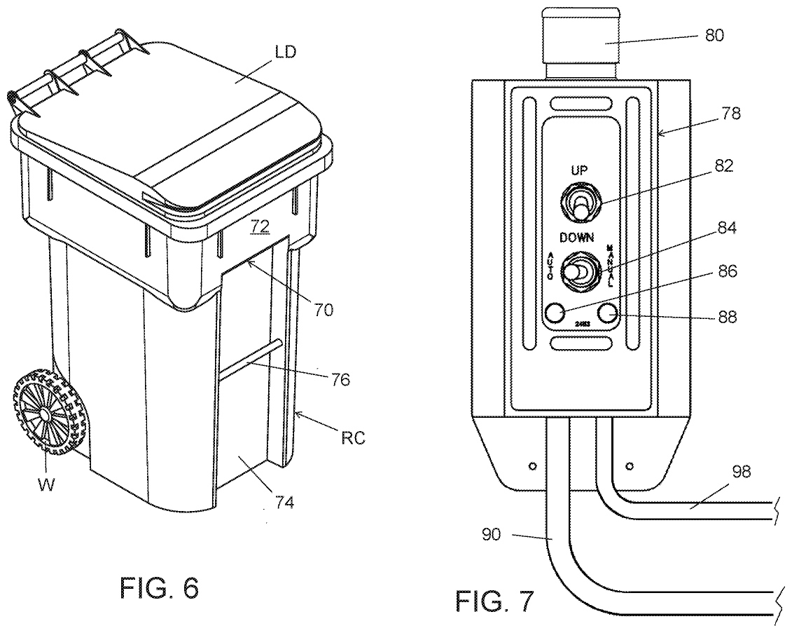

An example of a typical refuse container RC is shown in FIGS. 1 and 6. The refuse container RC includes a pivotable lid LD and wheels W. The example refuse container RC represents an example ANSI Type B wheeled refuse bin, which bins typically are constructed mainly of plastic and have a capacity range of 32-96 gallons. However, it will be appreciated that other refuse containers, such as ANSI Type C or other suitable refuse containers may be usable with the lifting device, and lifting devices may be constructed with particular dimensions to accommodate one or more alternative types of refuse containers.

The frame F includes the hopper H having a bottom or rear wall that slopes rearward and upward to the rear sill S. In FIG. 1, a first example lifting device 10 is located on the left and is in a lower position, tucked below the rear sill S of the hopper H. A second example lifting device 10 is located on the right and is in an upper position, to dump the contents of the refuse container RC into the collection cavity C of the hopper H.

In this example of a lifting device 10 connected to a frame F that is incorporated into a refuse vehicle V, the lower position of the lifting device 10, below the rear sill S, permits refuse containers RC to be lifted and dumped into the cavity C, while also permitting the lifting device 10 to avoid interfering with manually lifted items, or obstructing the dumping of larger containers into the cavity C of the vehicle V. With the lifting device 10 in the lower position, it also is less likely to contact the ground during driving or parking the refuse vehicle V.

The lifting device 10 includes a base 12 connected to a frame F. In this example, the frame F further comprises a hopper H having a rear sill S. The base 12 is shown being connected to a mount M in the form of a mounting plate, which is fixedly secured to the rear sill S, such as by welding or by use of fasteners or the like. The base 12 includes a planar portion 14, having brackets 16 extending rearward therefrom, and a channel portion 18 extending forward and downward from the planar portion 14. The channel portion 18 is conveniently integrated into the base 12 and located below and along the sloped rear wall of the hopper H.

The planar portion 14 of the base 12 has a plurality of apertures aligned with a plurality of apertures in the mounting plate of the mount M, such that fasteners 20, shown as nuts and bolts, may extend through the respective apertures and be used to removably connect the base 12 of the lifting device 10 to the mount M. It will be appreciated that base 12 may be mounted to the frame F by alternative suitable means of connection and in different locations, and the base 12 may be otherwise connected to a frame F that includes a hopper, but being connected along any side wall of the hopper, depending on the configuration desired for lifting and dumping refuse containers. The connection may be achieved by welding or use of fasteners or the like, whether directly to the frame or via other mounting structures, such as the mount M shown in this example as including a mounting plate for ease of removal and servicing.

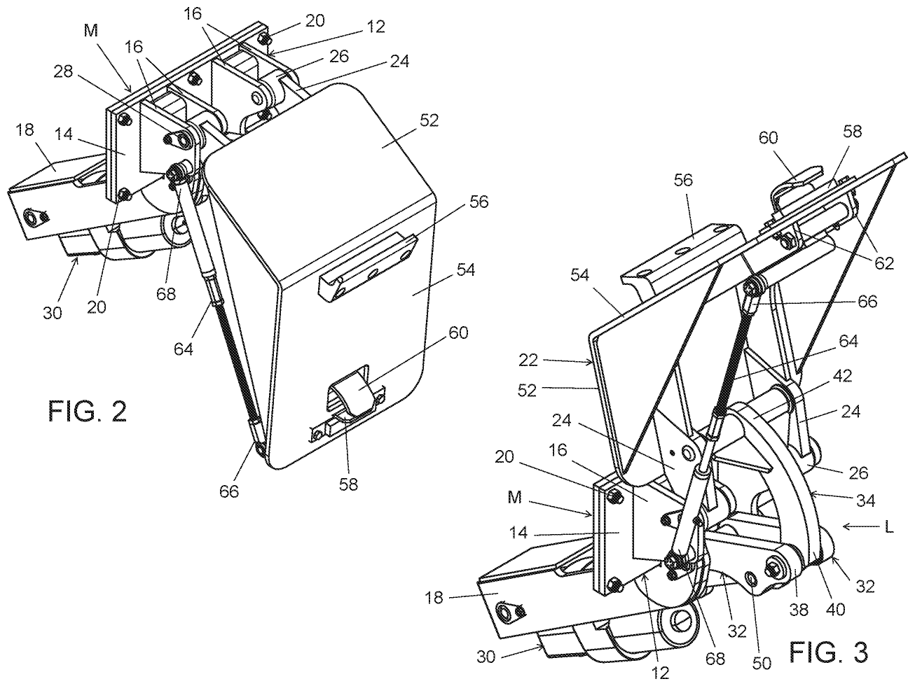

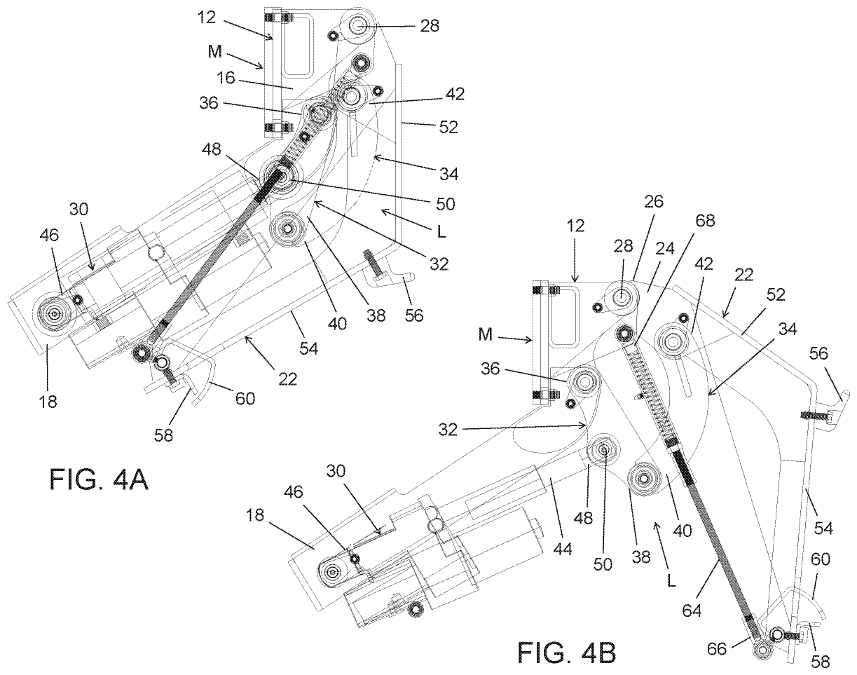

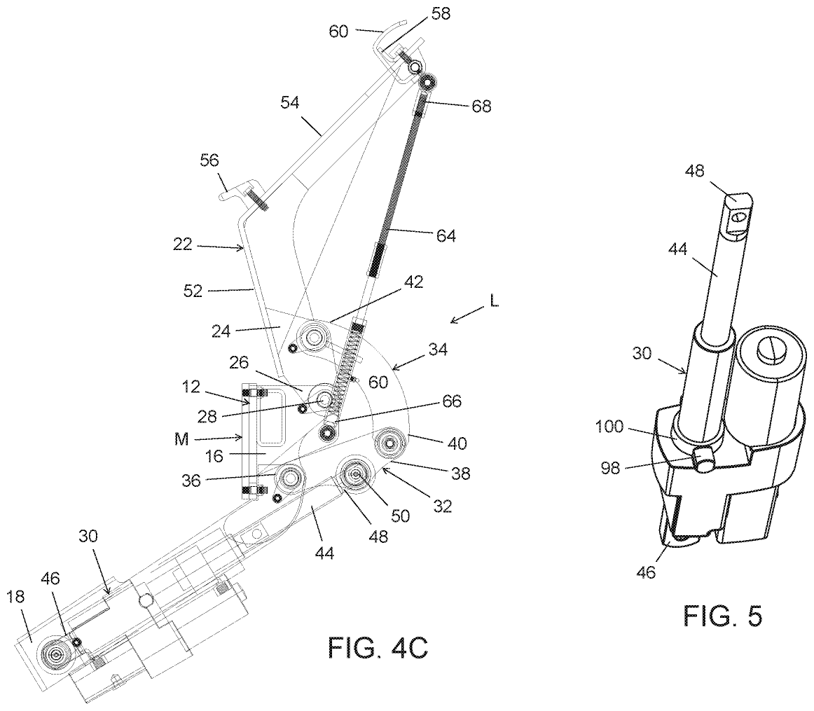

The lifting device 10 has a body 22 movably connected to the base 12 and configured to engage the refuse container RC. In the present example, the body 22 is pivotably connected to the base 12. The example construction includes the brackets 16 being fixedly secured to the planar portion 14 of the base 12, such as by welding. The body 22 includes arms 24 having ends 26 pivotably connected to the brackets 16 at pivots 28, as best seen in FIGS. 2 and 4A-4C.

In the present example, an electrically powered linear actuator 30 is connected to the base 12 and the body 22. The lifting device 10 is configured to move the body 22 from a lower position to a pick-up position to engage the refuse container RC when the refuse container RC is on a ground surface and to further move to an upper position to dump contents from the refuse container RC into the collection cavity C of the hopper H. In this example, the linear actuator 30 acts through a compact linkage L to move the body 22. As best seen in FIGS. 3 and 4A-4C, the linkage L includes a plurality of links that provide mechanical advantage utilized in pivoting the body 22 from the lower position to the upper position. The plurality of links includes a pair of link arms 32 that are pivotably connected to an arcuate link 34. The pair of link arms 32 are pivotably connected at first ends 36 to the base 12. The pair of link arms 32 also are pivotably connected at second ends 38 to a first end 40 of the arcuate link 34. The arcuate link 34 is pivotably connected at a second end 42 to the body 22 of the lifting device 10.

An example linear actuator 30 is shown in FIG. 5 in the form of an electrically powered ball screw linear actuator, which provides linear movement of a shaft 44. It will be appreciated that alternative suitable electrically powered linear actuators may be used. As seen in FIGS. 3 and 4A-4C, the linear actuator 30 is pivotably connected at a first end 46 to a forward end of the channel 18 of the base 12. A second end 48 of the linear actuator 30 is pivotably connected to the link arms 32 at pivots 50 located between the first ends 36 and second ends 38 of the link arms 32.

As seen in FIGS. 2-4C, for the example shown, the body 22 has an upper portion 52 extending along the arms 24, and then is bent to continue into a refuse container engaging portion 54. The container engaging portion 54 includes an upper hook 56 used to engage and lift a refuse container RC. The upper hook 56 may be constructed of a rigid or semi-rigid material, such as plastic or the like, to help avoid damaging the refuse containers RC. The container engaging portion 54 of the body 22 also includes a lower flange 58 to engage and help retain the refuse container RC when in the upper position, which includes inverting the refuse container RC to dump the contents into the cavity C of the vehicle V. It will be appreciated that the body 22 and linkage L may be alternatively constructed, while still utilizing an electrically powered linear actuator to engage, lift and dump refuse containers.

To ensure the lower flange 58 remains engaged with the refuse container RC, the body 22 includes a movable stop 60 that further comprises a hook that is pivotably connected to brackets 62 on the refuse container engaging portion 54, as best seen in FIG. 3. The movable stop 60 is moved automatically by a rod 64 between release and capture positions. For example, the rod 64 is pivotably connected at a first end 66 to the movable stop 60 and pivotably connected at a second end 68 to one of the brackets 16 of the base 12. Movement of the lifting device 10 between the pick-up position and upper position causes the rod 64 to move the movable stop 60 between the release and capture positions to help control the refuse container RC. The rod 64 may be adjustable in length, to accommodate varying dimensions, as needed.

An example of a typical refuse container RC to be lifted by the lifting device 10 is shown in FIGS. 1 and 6. The refuse container RC includes an upper grasping portion 70 on a side of a refuse container RC. The upper grasping portion commonly may be in the form of a bar or, as shown in FIG. 6, it may be integrally formed into a side wall of the refuse container RC, such as side wall 72, by including a central recess 74 that extends upward and behind a portion of the side wall 72. This will permit the upper hook 60 of the lifting device 10 to nest within the recess 74, while engaging the grasping portion 70, so as to help to keep the refuse container RC centered on the lifting device 10 when lifting the refuse container RC.

The refuse container RC also includes a mid-level bar 76 extending across the recess 74 in the side wall 72 of the refuse container RC. The bar 76 is engaged by the lower flange 58 on the refuse container engaging portion 54 of the lifting device 10. As previously noted, the movable stop 60 is actuated by the rod 64 when the lifting device 10 moves from the pick-up position to the upper position, such as when the lifting device 10 lifts and dumps the refuse container RC. Due to the location of the pivotable connections of the rod ends 66, 68, movement of the lifting device 10 from the pick-up position to the upper position causes the movable stop 60 to pivot toward the lower flange 58. This causes the movable stop 60 to capture the mid-level bar 76 on the refuse container RC between the movable stop 60 and lower flange 58. This blocks the refuse container RC from falling into the vehicle cavity C when inverted for dumping. In turn, when moving the lifting device 10 thereafter from the upper position to the pick-up position to return the refuse container RC to the ground surface, the rod 64 causes the movable stop 60 to pivot in the opposite direction, away from the lower flange 58, so as to release the mid-level bar 76. This permits the refuse container RC to be moved away from the lifting device 10, or permits the lifting device 10 to move to the lower position and to thereby separate and move away from the refuse container RC.

An electrical control system includes an electrical operator interface 78 is used by an operator to input commands. The operator interface 78 may be connected to the frame F, such as to the hopper H of a refuse vehicle V, directly or indirectly, so as to be in a convenient location to be utilized by an operator who is responsible for operating the lifting device 10. As shown in FIG. 7, the operator interface 78 may include a plurality of inputs, such as switches, buttons, and the like. The operator inputs in the present example include a safety energy stop button 80 atop the operator interface 78, with a first switch 82 having Up and Down command positions, and a second switch 84 having Manual and Automatic operating mode positions. The operator interface 78 also may include Indicator lights 86, 88, which may be configured to confirm the operational modes, movements and/or positions of the lifting device 10.

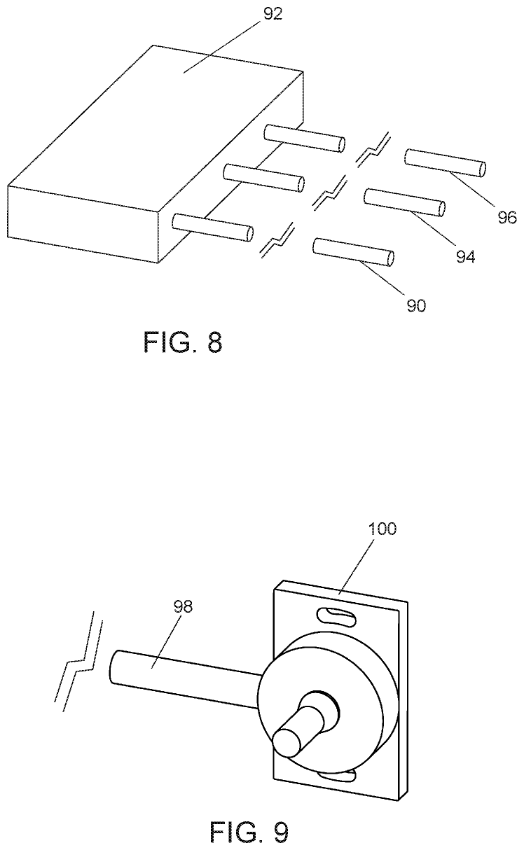

The operator input commands entered into the operator interface 78 are provided to a controller 92 via a cable or wiring 90, an example of which is shown in FIG. 8. It also will be appreciated that such commands alternatively may be provided wirelessly. The controller 92 is part of the electrical control system and receives and processes the operator input commands to operate the lifting device 10. It will be appreciated that the controller 92 may be mounted to the frame F or in the example wherein the frame F includes a hopper H integrated into the refuse vehicle V, the controller 92 may be mounted on or inside of in the refuse vehicle, remotely from the lifting device 10, so as to be protected from physical or environmental hazards.

The controller 92 includes a protective enclosure that contains a logic circuit and processor, such as a microprocessor or the like. The controller 92 may be electrically connected to other system components in the electrical control system by wiring, such as an example power cable 94 for connection to a power source, such as a vehicle or accessory battery. The controller 92 also may be connected to the lifting devices 10, such as by a control cable 96, which includes wiring to be connected to the electrical linear actuator 30 of the first lifting device 10 mounted at the left on the frame F at the rear sill S of the hopper H. Depending on the configuration of lifting devices 10 to be utilized, the control cable 96 from the controller 92 may include second wiring to be connected to the electrical linear actuator 30 of the second lifting device 10 mounted at the right on the frame F at the rear sill S.

Each lifting device 10 also includes a position sensor 100, which is shown in FIGS. 5 and 9. The position sensor 100 also is part of the electrical control system and is electrically connected to the operator interface 78, such as by the control cable 98. The position sensor 100 permits the controller 92 to monitor the position of the lifting device 10, such as the container engaging portion 54 of the body 22. Thus, the controller 92 may use the position sensor 100 and linear actuator 30 to determine the position and movement of the lifting device 10.

The controller 92 and its logic circuit and processor, along with the operator interface 78 and lifting device 10 comprise an operating system that may include an electrical control system having a unique controls package. For example, normal control of lifting devices in the refuse removal industry utilizes handles and/or levers that must be manually operated, such as by having an operator move a lever and hold it in a command position, such as to raise a lifting device until it achieves an upper dumping position. The operator then must move and hold the lever until the refuse container is returned to the ground surface.

In contrast, the present operating system for the lifting device 10 permits an operator to select between a manual and automatic modes of operation. When the operator uses the switch 84 to select the automatic mode of operation, the operator then is able to move the switch 82 to the Up position move the lifting device 10 to the pick-up position. Thereafter, the operator may again operate the switch 82 to start a lifting and dumping cycle of the lifting device 10. During the lifting and dumping cycle, the operator may move away from the operator interface 78, while monitoring operation of the lifting device 10. The operating system will automatically control the electrically powered linear actuator 30 to move the lifting device 10 from the lower position shown in FIG. 1 on the left side and in FIG. 4A, which typically is for storage while driving the vehicle or while lifting individual items or dumping other containers into the hopper H, to a pick-up position shown in FIGS. 2 and 4B. In the pick-up position, the container engaging portion 54 engages a refuse container RC on the ground surface, with the upper hook 56 engaging the grasping portion 70 of the refuse container RC and thereafter lifting the refuse container RC and moving it to the upper position to dump the refuse container RC, as shown in FIG. 1 on the right and in FIGS. 3 and 4C.

While the lifting device 10 is moving to the upper position, the rod 64 automatically actuates the movable stop 60 to block the refuse container RC from disengaging from the container engaging portion 54 of the body 22. Once the lifting device 10 reaches the upper position, the controller 92 will enter a dwell cycle to permit the contents of the refuse container RC to be dumped. The dwell cycle may be of a preselected duration and effectively provides a momentary rest period at the upper position. Following the dwell cycle, the electrically powered linear actuator 30 moves the lifting device 10 downward to return to the pick-up position, so as to place the refuse container RC back on the ground surface.

Accordingly, the electrically powered linear actuator 30, in combination with the position sensor 100, the user interface 78 and the logic circuit and processor of the controller 92 provide a unique operator control system having significant advantages. The system remembers set positions by use of the position sensor 100 and the logic circuit and processor of the controller 92. When in the automatic mode of operation and first moving the switch 82 to the Up position, the lifting device 10 may be moved from the stowed position for the first lifting and dumping cycle. Thereafter, the lifting device 10 will return to the same remembered pick-up position and be ready to for a different refuse container to be engaged for the next lifting and dumping cycle, which the operator may start by moving the switch 82 to the Up position.

Thus, when in the automatic mode of operation, the system may provide one-touch operation. This advantageously permits an operator to avoid the strain on muscles and joints associated with having to hold a lever or handle throughout a lifting and dumping cycle of a lifting device. In addition, it permits the operator to move away and gather one or more other refuse containers while the lifting device 10 is raised, dwells and then lowered to the pick-up position, wherein another refuse container may be exchanged for the refuse container that was just emptied. This will enable an operator to more quickly service a refuse collection route, especially in dense city environments where the next refuse containers may be only a few steps away.

Using switch 84, the system may be switched to the manual mode of operation. This permits an operator to operate the system manually, as may be desired when needing to make adjustments or corrections.

As noted, the embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

1. A lifting device for use in lifting and dumping a refuse container, the lifting device comprising:
a base connected to a frame that supports the lifting device;
a body movably connected to the base and configured to engage the refuse container;
an electrically powered linear actuator connected to the base and to the body;
wherein the lifting device is configured to move the body from a lower position to a pick-up position to engage the refuse container when the refuse container is on a ground surface and to further move to an upper position to dump contents from the refuse container, and to move the body to the pick-up position to return the refuse container to the ground surface.

2. The lifting device of claim 1, wherein the frame that supports the lifting device comprises a hopper and the lifting device is movable for lifting and dumping contents from the refuse container into the hopper.

3. The lifting device of claim 2, wherein the frame further comprises a sill of the hopper.

4. The lifting device of claim 3, wherein the base is connected to a mount on the sill of the hopper.

5. The lifting device of claim 2, wherein the hopper is integrated into or carried by a refuse vehicle or is freestanding.

6. The lifting device of claim 1, wherein the body further comprises at least one hook to engage a grasping portion of a refuse container.

7. The lifting device of claim 1, wherein the body further comprises a flange and a movable stop proximate the flange that engage and hold the refuse container when in the upper position.

8. The lifting device of claim 7, wherein the movable stop further comprises a pivotable hook that is moved to capture a bar on the refuse container when the lifting device is moved from the pick-up position to the upper position.

9. The lifting device of claim 1, wherein the body is configured to engage ANSI Type B and/or Type C refuse containers.

10. The lifting device of claim 1, wherein the body is pivotably connected to the base.

11. The lifting device of claim 11, further comprising a linkage connected to the base and to the body.

12. The lifting device of claim 11, wherein the linear actuator is connected to the body via connection to the linkage.

13. The lifting device of claim 1, further comprises an electrical control system for operating the lifter and which comprises a controller and an operator interface.

14. The lifting device of claim 13, wherein the electrical control system further comprises a position sensor that determines the position of the body relative to the base during operation of the lifting device.

15. The lifting device of claim 14, wherein the position sensor is connected to the linear actuator.

16. The lifting device of claim 14, wherein the controller further comprises a logic circuit and processor.

17. The lifting device of claim 13, wherein the operator interface further comprises a plurality of electrical inputs associated with controlling the lifting device.

18. The lifting device of claim 17, wherein the electrical inputs further comprise at least a “Stop” button associated with lifting device movement commands.

19. The lifting device of claim 17, wherein the electrical inputs further comprise a switch associated with lifting device “Up” and “Down” movement commands.

20. The lifting device of claim 19, wherein the electrical inputs further comprise at least one switch to select between at least a manual mode of operation and an automatic mode of operation.

21. The lifting device of claim 20, wherein the electrical control system further comprises a one-touch operation circuit which provides operation of a lifting and dumping cycle of the lifting device when in an automatic mode.

22. The lifting device of claim 21, wherein when the switch is used to select the automatic mode of operation, a one-touch operation circuit is started by actuation of a switch associated with an “Up” movement command, wherein the lifting device is moved from a lower position to a pick-up position to engage the refuse container, and the lifting device lifts the refuse container from a ground surface to an upper position to dump the refuse container, followed by a pre-selected dwell time in the upper position before returning to the pick-up position to set the refuse container on the ground surface.
